(19) United States
(12) Patent Application Publication
(10) Pub. No.: US 2013/0143670 A1
(43) Pub. Date: Jun. 6, 2013

(54) REGULATED GAME ASSET DRIVEN ECONOMY

(71) Applicants: William H. JUNKIN, Corona del Mar, CA (US); Chad ANDREWS, Los Angeles, CA (US)

(72) Inventors: William H. JUNKIN, Corona del Mar, CA (US); Chad ANDREWS, Los Angeles, CA (US)

(21) Appl. No.: 13/749,218

(22) Filed: Jan. 24, 2013

Related U.S. Application Data
(62) Division of application No. 11/797,805, filed on May 8, 2007.
(60) Provisional application No. 60/746,745, filed on May 8, 2006.

(51) Int. Cl. A63F 13/12

(52) U.S. Cl. 463/42

(57) ABSTRACT

A game asset driven economy and managing thereof are disclosed. The economic value of a game asset that has a utility in a game is estimated. The game asset can be traded in the game asset driven economy at a market price determined based on the estimated economic value of the game asset.

### RELATED APPLICATION

This application claims the benefit of U.S. Provisional Application No. 60/746,775, filed May 8, 2006, entitled “REGULATED VIRTUAL ECONOMY,” the disclosure of which also is entirely incorporated herein by reference.

### BACKGROUND

The present teaching relates to methods and systems for economics for assets that have no physical existence. More specifically, the present teaching relates to methods and systems for creating, managing, and regulating an economy driven by assets that have no physical existence and systems incorporating the same.

### DESCRIPTION OF RELATED ART

Recently, a phenomenon has arisen whereby players of computer or wireless games participate in real-money “virtual” economies. These economies are described as “virtual” because the assets bought, sold, or traded therein, do not really exist. Examples of such virtual economies include MMORPGs (Massive Multi-player Online Role Playing Games) where participants pay actual money for fantasy goods or in exchange for services rendered only within the world of a software-based game. These fictional goods and services enhance a playing experience or allow participants to earn profit by selling or renting virtual items they obtain or by providing their own virtual services.

Another example is a racing game where a player's racecar may comprise virtual upgrades, such as a larger engine or improved brakes. The engine and brakes do not physically exist, but rather are fictional assets, existing only within the game. However, the engine or brakes, or other car parts, can be purchased, sold, or traded within the game, very often for real money.

Yet another example of a game asset driven economy could include a game derived from fantasy sports. In a football video game, for example, the game pieces may represent actual athletes. Each piece has a relative functional worth within the game that is linked statistically to that player's real-world performance in live sporting events. If the game necessitated that pieces must be purchased, then there would exist a relative financial worth for each piece within an overall economic market for said pieces.

Often, the possession of virtual assets has value not only for a player's success within the game, but may also assist the player in obtaining other assets. For instance, a racing game may be set up such that a winner of a race wins one or more of the virtual parts from an opponent's car. Thus, a more powerful engine may assist a player in winning races, wherein additional virtual parts can be acquired through victory within that game. Because assets are sometimes bought or sold for real money, those who invest significant time and money in these games could actually produce a real world profit.

Currently, there are no means to regulate the supply or value of assets in these virtual economies. Static auctions may exist, wherein one player sells a virtual asset to the highest bidder. However, as new assets are introduced into the game asset driven economy after the initial price is set, changes to the worth of that asset must be specifically re-priced with human intervention. Likewise, most virtual economies permit an unlimited supply of the virtual asset to any players who are willing to pay the set price. If supply is controlled, for instance with the use of random insertion of the asset into various locations of the economy, there is no way to adjust the prevalence of such introduction without human intervention.

Many games that could incorporate virtual economies, such as traditional video games like the football video game example, do not currently do so in part because there exist no mechanisms by which to dynamically control and manage the supply versus demand of virtual assets in relation to the optimal economic price of these assets. Additionally, current games do not link assets to real-time, real-world factors that measure the value of each asset as it pertains to its relative function as a game piece. Furthermore, certain conditions must exist to enable the players of economized games to exchange virtual assets without engaging in illegal gambling, There is a need to create an underlying system of logical principles by which to enable and manage economies arising from the ever popular game worlds and to do so legally and effectively.

### SUMMARY

It is with the above object in mind that the present teaching was conceived. The present teaching is a method for dynamically managing a game asset driven economy that centers on a real-time market where virtual assets are bought and sold and where the financial market value of each asset, that is in turn a game piece, is determined in real-time, by software, through the real-time management of specific variables in relation to one another. Management is done by use of software to control the exact percentage of each unique asset in the overall game asset driven economy and to use the actual real-world performance of each game piece, coupled with real-world statistics specific to each individual game and game piece, to determine the frequency of an asset, its relative power as a game piece and its price.

Specifically, an initial price is set for each asset as deemed fit by game developers. Each individual game piece is then linked to a real-world measure of its performance. In a football video game, for example, a particular player's game piece may be linked to the statistics of a real football player. If a player has a good game, the functional power of the game piece linked to that player will increase as a specific function of algorithms created for that game that average the overall power of that piece with specific statistics from each live game. In a virtual car game, the measure could be an averaged function of a car part's winning percentage as it pertains to its function in the overall game and can also include real-world links between the performance of parts in actual live car races. Each game's rules and environment will determine which real-world measures are averaged with the value of each game piece (asset) with the overall effect being that real world events affect the value of each individual game piece in each game managed and the relative economic worth of each game piece fluctuates in accordance with real-world events. The specific algorithms will be appropriate for each game and different for each game, but the principle by which a game piece is linked to real world events is a central principle of these methods.

As a game piece's relative power scales, software introduces a number of methods to manage the overall game asset driven economy in recognition of the changing worth of each asset. The price and frequency of gaming assets had been previously controlled only through the basic laws of supply and demand. Thus, without the present teaching, the game asset driven economy would be subject to a dramatically higher occurrence of market inefficiencies and unpredictability, which works against those who wish to derive maximum profits in a controlled environment.

### BRIEF DESCRIPTION OF THE DRAWINGS

The teachings claimed and/or described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts an exemplary framework in which a game world economy is created and managed according to an embodiment of the present teaching;

FIG. 2 depicts a different exemplary framework in which a game asset based economy is created and managed according to an embodiment of the present teaching;

FIG. 3 depicts an exemplary framework for valuating game assets, according to an embodiment of the present teaching;

FIG. 4 is an exemplary block diagram of a valuation manager according to an embodiment of the present teaching;

FIG. 5 is an exemplary block diagram of a trade manager according to an embodiment of the present teaching; and

FIG. 6 is an exemplary block diagram of a market control manager, according to an embodiment of the present teaching.

### DETAILED DESCRIPTION OF THE PRESENT TEACHING

The present teaching describes a method and system for the creation, management, and regulation of an economy arising from the game world. Although the economy may be initially driven by virtual assets existing in the game world, the scope of the economy is not necessarily limited to the game world. That is, the exchange or trade of game assets may go beyond the game world. For example, game assets may be bought or sold for, e.g., investment purposes. In that sense, the game assets may give arise to a real economy instead of a virtual economy in which gamers exchange game assets not for profit but for game playing purposes. Therefore, although game assets may not have physical existence in the conventional sense, the economy arising from such game assets may lead to an economy in which virtual game assets may be exchanged, traded, transacted, or even rented for actual gain, whether monetary or personal.

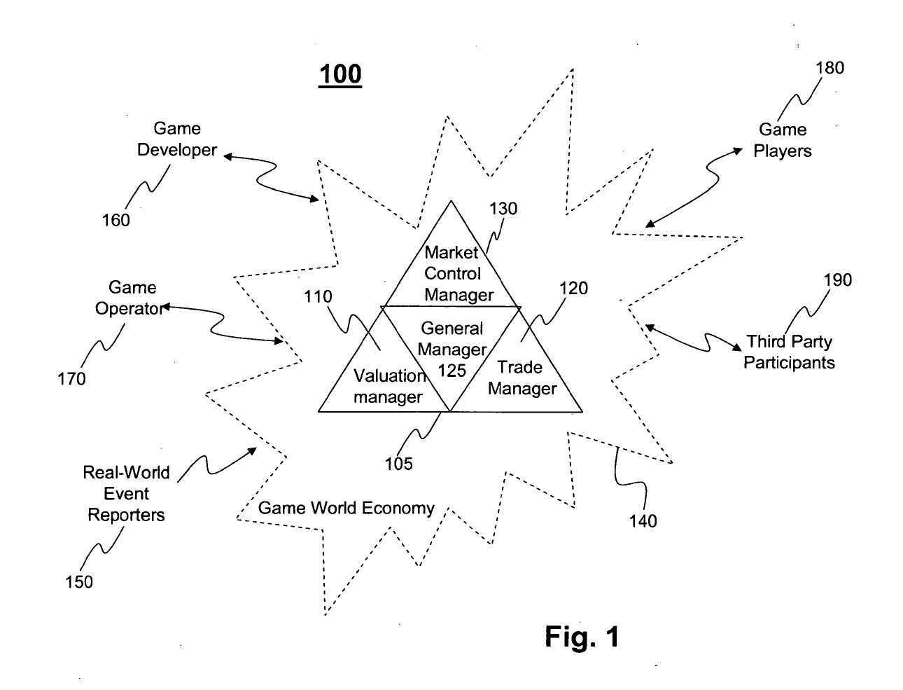

FIG. 1 depicts an exemplary framework 100 in which a game world economy 140 is created and managed according to an embodiment of the present teaching. In the game world economy 140, there are a plurality of participants, including game players 180, a game developer 160, a game operator 170, and a game world economy manager 105, which further comprises a game asset valuation manager 110, a game asset trade manager 120, a game asset market control manager 130, and a general manager 125. The driving force of the economy described herein is the game assets and various economical aspects of assets such as their value, trading, and market thereof.

In framework 100, the game developer 160 may comprise more than one game developer. Similarly, the game operator 170 may comprise more than one game operator. The game operator 170 may or may not be the same entity as the game developer. The game operator may be a part of the game developer or reside in the game developer. Alternatively, the game operator 170 may be an independent business entity and different from the game developer 160. The game players 180 include garners who play games developed by one or more game developers or operated by one or more game operators.

The game world economy manager 105 resides in the center of the game world economy 140 and is designed to carry out a variety of managerial tasks in relation to the creation of game assets, establishment of regulations associated with different aspects of game assets, dynamic valuation of game assets, management of the marketplace where game assets are traded, and management of other generic aspects of an economy. As illustrated in FIG. 1, the game world economy manager 105 may comprise a game asset valuation manager 110, a game asset trade manager 120, a game asset market control manager 130, and a general manager 125. The game asset valuation manager 110 may be responsible for providing the means for or the means to facilitate game developers to create assets and attributes thereof, assign the values of the attributes, establish links between attributes and the functional roles of the assets, and dynamically manage the assets such as adaptively valuating the market worth of game assets based on a variety of economic and functional considerations.

A game asset is set forth as anything that can be identified within a game that creates utility. The nature of assets varies greatly depending on the game. In Scrabble, the letter “S” is an asset. In a video game, a virtual car is an asset. In the same game, air in a tire or a part in the engine could also be assets if a player has any degree of control over how those things affect play. In a football game, a virtual player is an asset. Wind could be an asset in the same game if it assists in sending a kick further. In a horse racing game, a horse, or even a horseshoe, may be an asset. In a fantasy game, a sword or a spell may be an asset. A commodity such as gas used to fuel a virtual space ship can be an asset. Qualities such as durability and energy may be assets if those qualities are of use to a game's player.

Each game asset has attributes that determine how it functions and in what measure. The individual attributes of each asset and how they relate to the gaming experience may initially be determined by game developers. How assets create functional worth either individually or in tandem may also initially be established by game developers. An individual asset may have as little as one attribute assigned to it or may have complex computer code that governs the interrelation of various properties and characteristics that encompass the behavior of that asset. An individual property associated with an asset can be defined as an attribute of the asset. Since the goal of each game is different, it is generally true that the nature and scope of asset attributes vary with respect to the goal of each game. For example, wind, which may have attributes of speed and direction, may be considered as a game asset. The nature of the wind asset in a game may vary, depending on the game. In addition, the value of such an asset within each game may also vary depending on the attributes of the asset. Furthermore, the value of such an asset may dynamically change with, e.g., the whether report of an actual locale. For example, the values of speed and direction attributes of game asset “wind” in a ski game may be instantiated using the actual wind speed and wind direction reported at a ski resort on a particular day on which the game is played.

Attributes of an asset may be assigned values specified within the rules, conditions, or software code or algorithm of the game in which the asset is used. For example, a virtual football player within a game may have many attributes that determine how that player performs. These attributes, determined by game developers, may be such things as speed, strength, skill, heart, experience, stamina, luck, and endless other attributes. Specific assets may have attributes that are specific to it, such as the ability to be effective in certain conditions or in combination with other assets or variables. An asset that is an individual part in a virtual car may have attributes that create functional value such as its efficiency and even its rate of depreciation.

Generally, an attribute has some kind of statistical value assigned to it that determines the degree of its functionality or its utility versus the attributes of other assets. Attributes of a certain asset may be tied to attributes of other assets. It may be dictated within the computer code of a car racing video game, for example, that a certain kind of tire performs better on an asphalt race track than on a gravel racetrack. The synergy between a certain tire and a certain track may be defined within the attributes for the tire, the track or both. How one asset will perform in relation to other assets is affected by the attributes of that asset and is defined by game developers. At any one moment in time, the various attributes of the assets in a game are fixed. However, the values assigned to the attributes of a game's assets may (or may not) change.

Game assets may have either virtual or actual economic values. Such values may vest in a marketplace in both a game world or a general economic world. Game assets with market worth can be bought, sold, rented, auctioned, borrowed with interest, or trade in any fashion that is applicable to normal goods with value in the commodity market. In the teaching described herein, the game asset trade manager 120 is responsible for conducting such economic activities with respect to game assets. Transactions associated with game assets can be conducted among garners. For example, when a gamer wins a game, he/she may be entitled to take a certain percentage of the loser(s)' game assets. In this situation, the ownership of the involved game assets changes hands and there may be specific acts that have to be performed to ensure the change in ownership may be performed by the game asset trade manager 120. Transactions associated with game assets may also involve parties who are not garners. For example, an investor may purchase or sell game assets for profit. Game assets may be put on auction open to general public. In this manner, game assets enter into the general stream of commerce and can be traded as commodities in the marketplace.

Given the existence of a marketplace driven by game assets, there exist various aspects of the economy associated with that market that may need to be managed. The game asset market control manager 130 is responsible for different aspects of the game world economy 140 relating to market management such as monitoring the marketplace within the game world, devising dynamic strategies to be deployed to ensure a healthy economy, or exercising control over the market to balance demand and supply. The game asset market control manager 130 may monitor the dynamics of game assets movement in the game world economy and conduct or control certain activities such as buying back assets, limiting new release of certain assets to the marketplace, etc. in order to foster a desirable supply-demand balance in the marketplace. For example, if there appears to be a trend that a particular piece of game asset may become over populated, the game asset market control manager 130 may curtail any new release of the same game asset from game developers in order to prevent over population. As another form of control, the game asset market control manager 130 may also buy a certain quantity of the asset to control the level of availability of the asset in the open market.

There are other generic managerial issues associated with the game world economy. The general manager 125 is designed for managing all other aspects of the game world economy. For example, as described below, each player in the game world may have an account and such accounts may need to be managed according to certain rules. Such accounts may also be managed in a manner that are consistent with the economic goals of the game world economy. For example, each player's account may be managed based on some rules devised by market control manager 130. For instance, the market control manager 130 may require that each player have an inventory of a limited size (i.e., with a limited number of game assets in the inventory) and each game asset in the inventory have a limited life time (e.g., when the life time is up, the player may be required to sell or dispose the game asset). The general manager 125 may be designed to manage the players' accounts in accordance with such policies.

Therefore, in framework 100, the game world economy manager 105 is deployed to oversee and manage different aspects of the game world economy 140. Such may be achieved by positioning the manager 105 in the center of all activities occurring in the game world economy, interacting with different participants of the game world economy, and exercising direction over activities performed by such participants. In other words, the game world economy manager 105 plays a central role in creating, monitoring, and managing the game world economy 140.

In some embodiments, the game world economy manager 105 may be deployed as an entity, independent of any participants, yet may interact or interface with different participants of the game world economy to manage different aspects of the game world economy. This is shown in FIG. 1. In other embodiments, the game world economy manager 105 may be deployed within a game developer or a game operator, as part of their systems, to manage the relevant aspects of the game world economy (not shown). In some embodiments, the game world economy manager 105 may partially reside inside a game developer or a game operator and partially reside outside of game developer/operator as an independent system. In this case, the part that resides outside of the game developer/operator may interact or interface with the part residing inside the game developer/operator in order to manage the game world economy. For instance, the game asset valuation manager 110 may be deployed within the game operator 170 in order to efficiently facilitate game developers in creating game assets in a flexible manner, performing dynamic valuation of the game assets, and managing the dynamics of the game assets. In the meantime, the game asset trade manager 130 may be deployed as an independent entity, outside of the game developer/operator, in order to effectively manage the trade aspects of the game world economy, which may involve garners associated with different game developers/operators.

There may be other optional participants in the game world economy 140. For example, framework 100 also includes real-world event reporters 150 and third party participants 190. The teaching as described herein allows real-world events to influence the game asset valuation. Upon on occurrences of real events, the real-world event reporters 150 report such occurrences to the game world economy manager 105, which then invokes appropriate mechanism(s) to update the valuation of game assets that are known to be associated with the occurrences of the reported events.

The third party participants 190 may include those parties who, e.g., provide services to the other participants of the game world economy. For example, the game world economy manager 140 may contract with a third part service provider to perform accounting related to trading game assets. In framework 100, the scope of the economy 140 is limited to the game world and the association thereof. The game assets, including the creation, valuation, trading, and management, are influenced by participants who have an association with the game world.

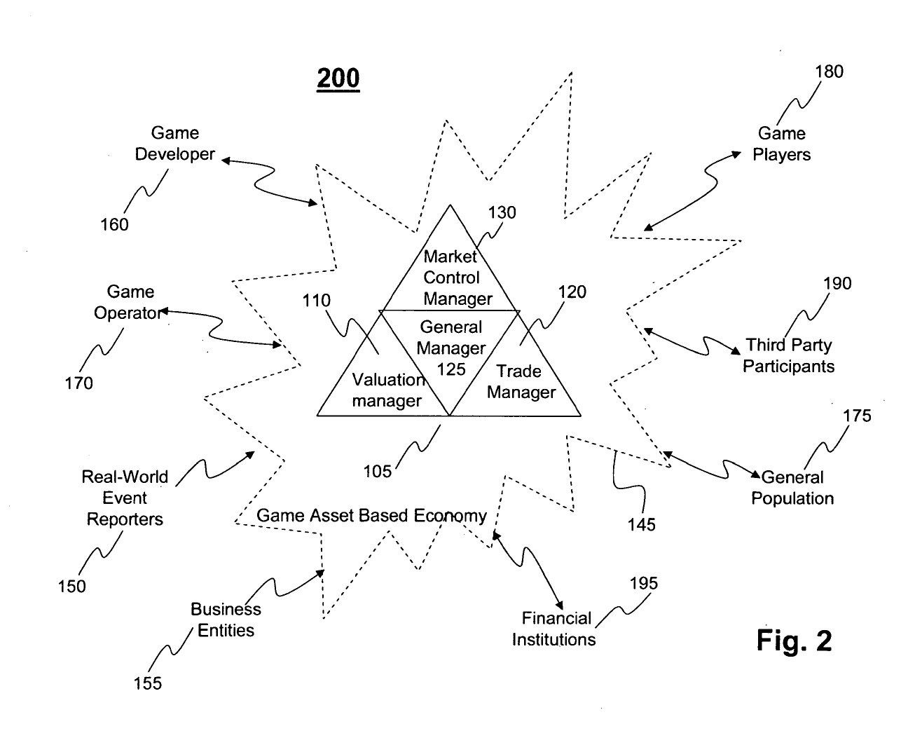

As discussed above, the scope of an economy arising from the game world does not have to be limited to the game world itself. FIG. 2 depicts a different exemplary framework 200 in which, although an economy 145 is driven by game assets, the scope of the economy is not limited to the game world itself. This is evidenced by having participants who are not associated with the games in the game world or who do not play games. In addition to the participants illustrated in FIG. 1, the exemplary framework 200 includes further the general population 175, financial institutions 195, or other business entities 155.

In the game asset based economy 145, all aspects as described in association with the framework 100 apply with additional features described herein. In framework 200, game assets are no longer limited to being objects that can be traded among garners; they are now assets that have a market value in the general marketplace. The game assets in this framework 200 are commodities that can be transacted by parties who are not garners and outside of the game world. For example, a person in the general population 175 may now purchase or sell a piece of game asset at its market price, even though the asset is of no physical existence and is of no gaming interest to the person. The person's desire to transact the game asset can be simply profit motivated. Similarly, a financial institution 195 such as an investment bank may also decide to invest in game assets even though there is no physical existence of the asset. Furthermore, any business entity (155) may now have financial interest in game assets as long as there is a possible financial gain and benefit.

To realize or implement the manager for the game world economy (in framework 100) or the game asset based economy (in framework 200), one or more computers or devices may be used with one or more databases, either centralized or distributed. Such databases may be used to maintain the state of the game asset driven economy (including both the game world economy in framework 100 and the game asset based economy in framework 200). This state of the economy may be represented by current existing game assets and the distribution thereof, the market worth of each existing game asset, their attributes and/or ownership in the marketplace, and any other variables associated with the asset that may or may not be unique to that category of asset.

The detailed discussion below relates to the manager 105 (in both FIGS. 1 and 2) for the game asset driven economy (both 140 and 145). In some embodiments, the manager 105 may reside on a centralized server or may be distributed. Different computers hosting different portions of the manager 105 may work together in either a synchronous mode or an asynchronous mode.

As discussed above, a piece of game asset within the game asset driven economy may be of anything that has some sort of utility, which can be of practically any nature. Examples of game assets include virtual weapons, armor, potions or other similar items that may be of use in a fantasy role playing game; automobile parts and upgrades that may be used in virtual racing leagues; or players in fantasy sports leagues. By way of example, with respect to fantasy sports leagues, the assets being “cards” representing real life players, the manager 105 would use algorithms to determine each card's strategic worth in relation to each other card. The manager 105 can consider various factors in determining the market worth of a piece of game asset.

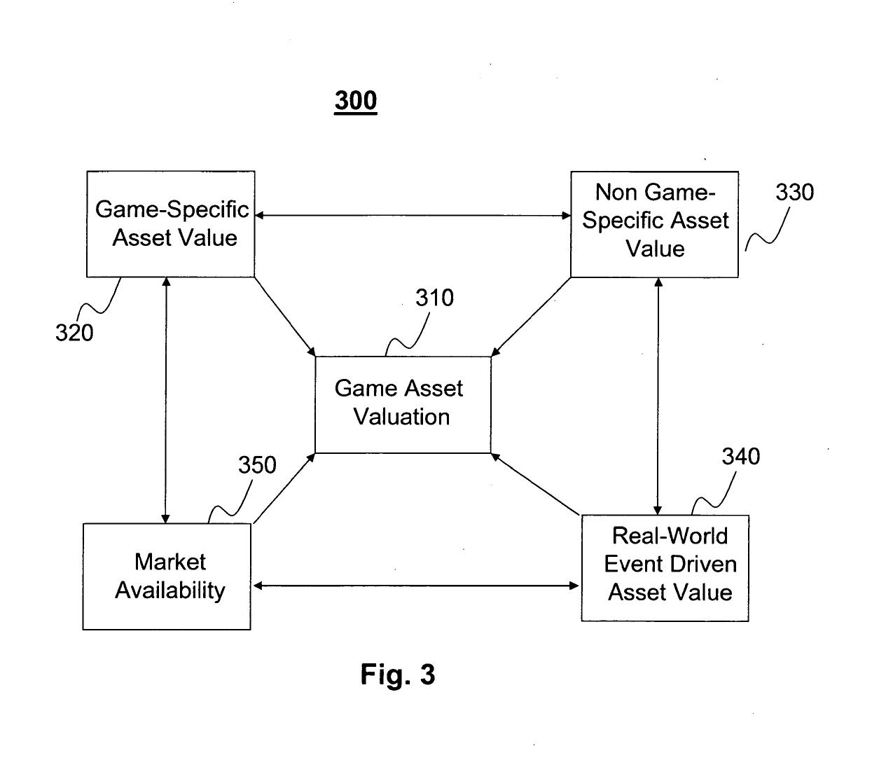

FIG. 3 depicts an exemplary scheme 300 for valuation of game assets, according to an embodiment of the present teaching. In this scheme, the market worth of a specific piece of game asset may be determined as a combination of its values evaluated from different perspectives. For example, the overall value of a piece of game asset may be determined based on both its game specific asset value 320 (the value of the asset with respect to a specified game) and the non game specific asset value 330. In addition, the value of the asset may also depend on other factors, e.g., the market availability of the asset 350.

The value of a game asset to a specific game may be determined based on the goal of the game and other considerations. The initial value of an asset to a particular game may be first specified by a game developer and such initial value may be updated over time depending on how its value is linked to other variables. The conditions appropriate for each game may affect the precise mechanisms by which variables are linked to asset attributes. Each asset's market price may scale as a function of the relative power of the game piece averaged with what consumers paid for that item over a specific number of past purchases. Each asset's relative price changes in real time and that dynamic value is adaptively updated by the asset valuation manager 110.

In some embodiments, the value of the asset may be linked to the occurrence or lack thereof of some real-world event 340. For example, if a game asset is a virtual athlete, the market worth of this asset at any moment may then depend on the real-life performance of the real-life athlete at that time. It is much like if a sports card is associated with a well-known real-life athlete, then the value of the card is often directly related to or determined by how the athlete performed in a recent game. For instance, if a baseball player performed exceptionally well in recent weeks, and thus had a higher batting average, this would likely increase the value of a game card corresponding to the athlete.

If an asset's value is scaled upward, a gamer who owns that asset may find it statistically easier to win contests by using that asset as a functioning game piece. An increase in its ability to function more effectively in the game world may also scale up the market price of the asset in the general marketplace because purchasers (whether a gamer or not) would be willing to pay more for the asset.

As described above, a game asset has attributes and such attributes may be assigned value. The market worth of the asset may relate to the values assigned to the attributes of the asset. The game asset valuation manager 110 as described herein may provide tools or interfaces that allow, e.g., a game developer or a game operator, to define interrelations between asset attributes and other variables that affect the attribute values. Such definitions may be made when the asset was initially created and/or dynamically during the lifetime of the game asset. The interface(s) provided allows a game developer/operator to define asset attributes and values thereof in a flexible manner.

Using such interface(s), a game developer can also create or define relationships, e.g., between the performance of a certain tire in a car racing video game and the current real-world weather conditions at a particular place, such as an actual racing track. The relationship defined may simply link certain attributes of a game asset to the occurrence of an actual real-world event or a natural phenomenon. For example, certain attributes of game asset “tire” (such attributes may relate to the performance of the tire on a racetrack) may be linked to the whether condition at a locale where a particular car racing team is competing. If the team is competing at Indianapolis Speedway, the attribute values of such a tire game asset may change in a manner consistently with the actual weather reported at Indianapolis Speedway, e.g., the wind at the speedway, the barometric pressure, the temperature, and precipitation. In this way, occurrences of real-world event or phenomenon may be programmed to have separate or combined effects on attributes of game assets and, hence, on performance of such game assets in the game world.

The game asset valuation manager 110 may also facilitate the ability to link other variables such as the economic value of assets and the frequency of individual assets in the gaming universe to the attributes of the same asset (e.g., a virtual tire) such that changes in any of these variables could affect the attribute values in these assets and vice versa. For example, a decline in the effectiveness of a certain tire because of rain at an actual race track could be linked to a decline in the economic worth of that asset. As the price falls accordingly, the manager 105 may accordingly invoke the game asset market control manager 130 to require that fewer instances of that asset exist in the game's universe to correspond to falling demand for that asset. In other embodiments, game developers may decide to tie the supply of the asset in the game's universe to actual demand for that asset in stores.

In the manner as described herein, the game asset valuation manager 110 provides game developers/operators with tools needed to flexibly link variables to different aspects of the game assets such as to asset behavior, to the availability of the asset in the marketplace, and its economic value. A user (e.g., game developer) of the interfaces provided by the manager 110 can specify the attributes of game assets based on real-world events and use the same to determine the functionality and value of the game assets. The user can also use the interface to instruct the game asset valuation manager 110 to use averaged performance over a specified period to derive the attribute value of a game asset. It is also possible to specify multiple factors to be averaged in to the performance of an asset and then to manage the changes to the asset's attributes accordingly.

One example is that actual fantasy sports scoring methods employed during real sporting events can be specified to affect certain attributes of individual gaming assets, such as the performance of virtual players that are fashioned after real-life counterparts. If the attributes of a virtual football player within a game are tied largely to the real-world performance of a player in the real world, and that player plays very well, then the attributes of the asset will probably be specified by game developers to rise. The asset will have more utility in the game in correlation with an actual sports event or events. In some embodiments, via interfaces provided by the manager 110, a game developer may specify that the values of certain asset attributes change as a function of changes in values of other attributes.

Depending on the interrelationship specified, as real events occur, the market worth of each asset may scale up or down accordingly. Additionally, the actual recent prices paid for assets when sold between two participants may affect the value of the asset, which is dynamically computed by the manager 110. As indicated in FIG. 3, the market availability 350 of a game asset may also affect the valuation thereof in a supply-demand relationship. Although the decision relating to how and to what degree specific variables are linked to the attributes of an asset may be determined by a game developer, the game asset valuation manager 110 is designed to facilitate the ability to create game assets flexibly with a wide variety of properties and the ability to evaluate the dynamic values of such created game assets accordingly by taking into account a possibly complex set of considerations when a piece of game asset is being valuated.

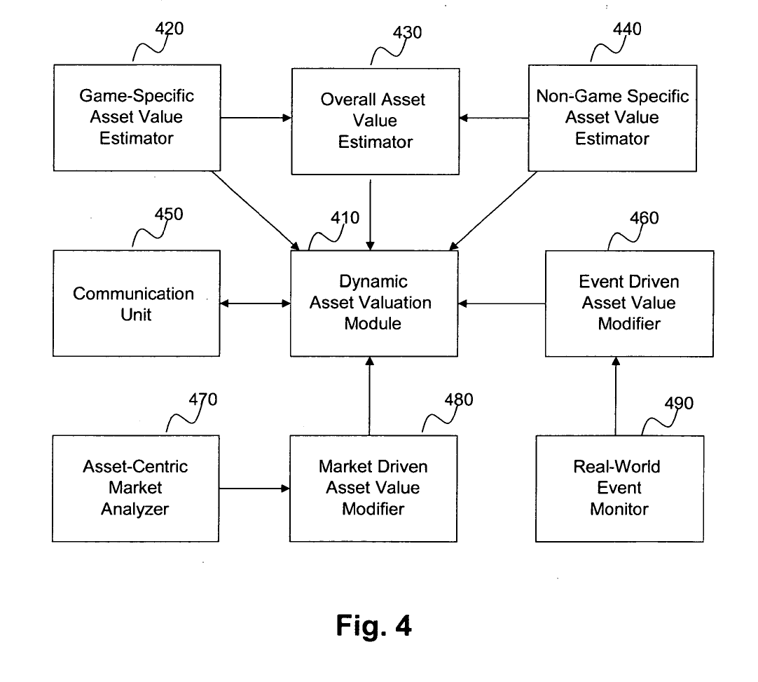

FIG. 4 depicts an exemplary construct of part of the game asset valuation module 310 that performs dynamic valuation of game assets, according to an embodiment of the present teaching. While the game asset valuation module 310 may also include a part of the processing in which it provides interfaces for interacting with a game developer in creating and specifying a piece of game asset, the construct depicted in FIG. 4 relates more to its operational part that adaptively updates the value of game assets. This exemplary construct comprises a dynamic asset valuation module 410 that interacts with the outside world on all aspects related to the dynamic value of game assets and such interactions include receiving a request to perform a valuation on a particular game asset and return the valuation results to the requester. The interaction may also include communication of information that is useful in performing dynamic valuation of a requested game asset. The interaction with the outside world is through a communication unit 450.

The dynamic asset valuation module 410 may estimate the value of a game asset at a particular time based on multiple considerations such as the game specific value of the asset, the non game specific value of the asset, the impact of some real-world event on the value of the asset, or the impact of the supply-demand status of that type of game asset in the marketplace on the value of the asset. A game specific asset value estimator 420 may be designed to estimate the value of a piece of asset with respect to a particular game, for example, the attribute values of the asset at that time and how such values affect the performance of the asset in the game, etc. A non-game specific asset value estimator 440 may be designed to estimate the general value of the asset in either the game world alone or in the general world. How this non-game specific estimator operates may depend on the scope of the asset. For example, the asset may have value only in games in which it is used. So, the universe in which this asset is being valuated may include only those games in which this asset has some utility. Since the degrees of utility of the same asset in different games may vary, the non-game specific asset value estimator 440 may employ some formula to combine the values in different games to derive an estimated non-game specific value.

The estimated game specific asset value may be combined with the estimated non-game specific asset value to obtain an estimate as to the overall asset value. This is performed by an overall asset value estimator 430. Depending on the request for the valuation, the way the two estimates are combined may vary. For example, if the breadth of the asset is more important, the overall asset value estimator 430 may allow the non-game specific value to have more weight (e.g., game specific value will be weighed 20% and the non game specific value will be weighed 80%). If the value of the asset with respect to a particular game is more important, the overall asset value estimator 430 may allow the game specific value to have more weight (e.g., game specific value will be weighed 90% and the non game specific value will be weighed 10%).

The dynamic asset valuation module 410 may opt to take the game specific asset value estimate from 420, the non-game specific asset value estimate from 440, or the overall asset value estimate from 430. Such decision may be made based on a request received. For example, if a request is for a valuation in the context of a particular game, the game specific value may be selected. Based on the selected estimate, the dynamic asset valuation module 410 may allow the selected estimate to be modified by an amount from either an event driven asset value modifier 460 or a market driven asset value modifier 480.

The event driven asset value modifier 460 generates a modification to an estimated value of a game asset (selected by the dynamic asset valuation module 410) based on an occurrence of a real-world event observed by a real-world event monitor 490. The modification may be generated based on a previously defined link between the observed real-world event and the attribute(s) of the asset to be valuated. The market driven asset value modifier 480 generates a modification to an estimated value of a game asset (selected by the dynamic asset valuation module 410) based on the market status indicated by an asset-centric market analyzer 470. That is, when a request to valuate an asset is received, a market analysis that may be centered on the asset may be performed. Such analysis may include supply-demand of this particular type of asset in the marketplace, the past price that this asset has been traded for, the projection of the price of the asset, etc. Such analysis results are fed to the market driven asset value modifier 480 so that it can accordingly generate a suggested modification to the estimated value and send such suggested modification to the dynamic asset valuation module 410. The construct illustrated in FIG. 4 may not include other components that may be implemented and deployed in the system described herein.

In the game world, anything that can assist a player in achieving a goal in a game is an asset. If something is an asset, it has value. If something has value, it can be bought and sold and can be economized using the method and system described herein. If something that is bought allows a player to obtain further assets by owning it, then the value of the asset becomes greater in proportion to the utility of the asset. By being able to manipulate the utility of an asset, one may optimize the economies associated therewith using the method described herein.

A game has entertainment value to players. Players are willing to pay for this enjoyment. The teaching described herein takes gaming to another dimension as it relates to both the enjoyment of garners and to the revenue potential of game developers, players, or even other non-gamer market participants. By tying the value and utility of an asset to things that a knowledgeable or skilled player can predict or learn to predict, the teachings described herein enables creation of a greater degree of entertainment value as well as economic incentive for garners and non-garners. As in the general marketplace, knowledgeable investors, including garners, have the opportunity to invest in assets that are tied to predictable variables. For example, if an asset is tied to the performance of a real-world athlete, then if an intelligent sports fan can anticipate that an athlete will excel, then he can also anticipate that the asset fashioned after that athlete will likely appreciate in value and utility.

The ability to link assets to multiple variables may further offer game developers the ability to create value for garners. For example, if a game piece is tied to the performance of an athlete in real life and the economic value of the asset is specified as a function of the number of consumers who paid for the asset over a period of time, then both the utility of the piece as it performs in the game and the demand for that piece in the marketplace can be taken into consideration in determining the economic value of that piece of gaming asset. A participant who was able to anticipate the performance of the athlete in advance may reap multiple benefits by owning the asset tied to that athlete.

The game asset trade manager 120 is provided to facilitate the economic activities associated with game assets. The game asset trade manager 120 provides means to allow assets to be exchanged, auctioned, transacted, rented, or borrowed with interest. For example, the outcome of a contest in the game world may be that the winner takes a certain percentage of the loser's asset inventory. In this case, the ownership of certain asset pieces need to be changed and the underlying inventories of both the winner and the loser need to be updated accordingly. In addition, the game asset trade manager 120 may also facilitate by providing appropriate tools and means that allow game developers to capitalize by creating sub-markets and allowing players to make deals with each other within games. For example, if a player wishes to own several cars in a virtual car race, but cannot drive them all, then within the game, the player can pay a driver a commission or fee to operate his vehicle. Similarly, if the game necessitates a “pit crew” to change tires, a team owner can pay effective garners a rate or commission to perform tasks. The incentive for someone paying these fees is that if he or she fields an effective team, a profit can be reaped above the price of goods and services required to manage an effective effort.

In addition, some garners may desire to purchase certain assets from other garners or whoever owns the assets to improve the ability to play. In this case, the game asset trade manager 120 provides the appropriate interactive means or interfaces as well as backend processing capabilities that support such parties to negotiate, to conduct transactions, and to carry out necessary steps to conclude the deal (e.g., update the record, evidence the change of ownership, etc.). Furthermore, investors who invest in game assets for profit may also trade game assets whenever the timing is appropriate. In this case, the game asset trade manager 120 provides appropriate interfaces and backend processing means to facilitate such economic activities.

The game asset trade manager 120 may also provide appropriate tools, interfaces, or backend processing capabilities to facilitate game asset auctions. The game asset trade manager 120 may provide an interface for auction sponsors to specify the forum in which an auction is conducted. Exemplary forums include a specific game (auction internal to a game), cross game forum (involving a number of games), or general (open to both the gaming world and the general population). The game asset trade manager 120 may also allow an auction sponsor to specify the rules that govern the auction (e.g., the lower and high bound of the auction price, etc.). Additional tools may be provided that allow an auction sponsor to enlist the goods to be sold, associated description of the goods, and the condition of the goods, etc. Furthermore, the game asset trade manager 120 may also provide special processing ability configured based on the sponsor's specification of the auction that will be used as backbone support for the auction. In the game asset driven economy, an auction may be used as a means to introduce new assets to the market (after they are created by developers,) to remove assets from the market.

The game asset trade manager 120 may also facilitate capital flows associated with game asset trade. For example, certain mechanisms may be deployed to conduct secure transactions such as managing payments made to and from the market and/or the gaming universe. A clearing house may be part of the trade management scheme so that payment for purchased game assets may be verified prior to concluding a transaction. In some embodiments, the game asset trade manager 120 may facilitate commission payment on sales or impose conditions to be observed, e.g., conditions under which certain assets should be removed or added into the game universe. The game asset trade manager 120 conducts all trade activities by complying with rules in the marketplace. Such rules may be established by government or trade organizations. In some embodiments, the game asset trade manager 120 may also participate in establishing or creating rules to be enforced within the gaming universe or market. For example, certain rules may be introduced that govern whether certain assets can be bought at a discount rate and when the discount rate applies and under what conditions.

The game asset trade manager 120 may also facilitate other types of economic activities with regard to game assets. For instance, it may provide facilities such as an online bulletin board interface where an advertisement may be placed for renting game assets with specific terms or further provide a virtual rental agency deployed to help the owner of game assets and renter to conduct a rental lease and enforcement thereof.

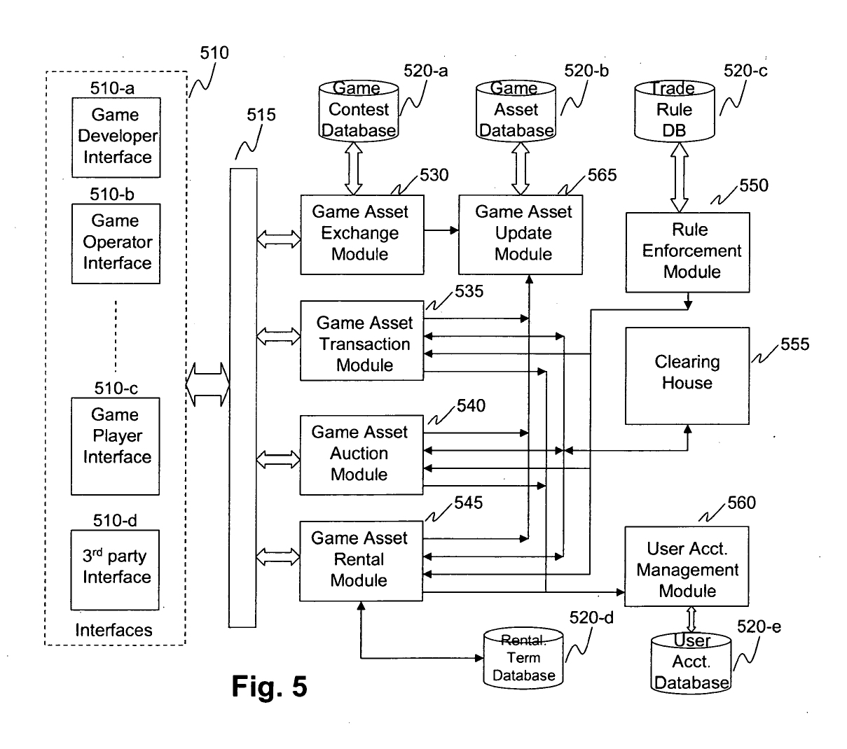

FIG. 5 depicts an exemplary internal diagram for the game asset trade manager 120 according to an embodiment of the present teaching. The game asset trade manager 120 may comprise a plurality of interfaces 510, an internal communication platform 515, a plurality of databases 520, a plurality of trade related operational modules 530, 535, 540, and 545, a module 550 for enforcing the trade rules in all transactions, a game asset update module 565, and a user account management module 560. The interfaces are provided for interaction between the game asset trade manager 120 and other parties such as a game developer (interface 510-a), game operator (interface 510-b), game players (interface 510-c), . . . , and any third party participant (interface 510-d) (e.g., investors or advertisement agencies). The databases are provided to store and update records associated with different aspects of the game asset trading. For example, the game contest database 520-a is for recording the outcome of the games. There is also a game asset database 520-b that may record all game assets, their attributes, and other features associated therewith such as the owner, the price of the last trade, etc. The trade rule database 520-c is for storing rules that govern different types of trade related activities, including advertising, asset exchange as an outcome of a game contest, buying/selling in the normal course of trading in the marketplace, or rental of game assets. When game assets change hands, records as to who owns what need to be recorded. The rental term database 520-d may record terms agreed to under each lease for each game asset so that the enforcement can be carried out according to the agreed terms. The user account database 520-e records information related to parties who trade game assets such as name, identification, financial status, last few trades, payment type, etc.

The internal communication platform 515 facilitates communications among different internal modules/interfaces. Through this platform, various modules, each of which may be responsible for a particular type of game asset trading, gather information via corresponding interfaces and send information to such interfaces. For example, the game asset exchange module 530 may communicate with a game operator to monitor the contest outcome.

There are different types of trades of game assets according to the teaching described herein. For example, some players may prefer to play the games in a mode that does not necessitate the risking of assets. If a player wishes to engage in a contest with other players, he or she may agree upon a pre-determined stake whereby a set percentage of assets utilized in the contest will be at risk. At the end of each contest the agreed upon percentage of assets is transferred from the loser(s) to the winner(s) in accordance with the agreed upon stakes. This is a form of exchanging game assets. The specific assets transferred could be chosen randomly or according to some agreed upon formula. In this manner, players can use intelligently designed and managed inventories of game pieces to win assets from opponents. If these assets have real-money worth and can be traded in marketplace, e.g., at an auction, the player who wins can trade the won assets or may also opt to use the strategic worth of acquired assets to win more assets from opposing players.

A concrete example of the exchange of assets can be demonstrated using the example of a car racing game. Consumers race cars against each other on a series of tracks, with varying weather conditions and other variables. Each consumer may initially be given a car with some fixed low asset value compared to other cars. Each car may contain dozens of parts that can be replaced. Within the overall games, hundreds or even thousands of specific parts are available with different functional value for each. Depending on the rules of the game, a player may also decide to race his or her car for free, or may decide to challenge another competitor to a race with a pre-determined stake. If the stake includes winning parts from the loser, the winning player may choose to use those parts won to improve their own car, or to sell them for money, which could be used to buy other parts that are more useful to him or her.

Another form of game asset trade is to acquire game assets. In order to become more competitive, a player may decide to increase the functional ability of his or her car by acquiring parts, which can be accomplished in a number of ways. For example, a player may decide to purchase parts—either individually or in packages in order to improve the performance of their car. The cost of the parts may be determined by some combination of the utility of those parts, the market value of those parts (base on recent sales), or the availability of those parts.

There are also other forms of asset trading such as auction of rental. To facilitate different forms of game asset trading, the trade manager 120 provides various modules to manage desired trades among players, investors, or a combination of different parties. For example, the game asset exchange module 530 is responsible for carrying out asset exchanges between players who decided to carry out a contest for game asset exchange at a stake. When the contest ends, the game asset exchange module 530 may then carry out asset exchange according to the terms of the game, e.g., a winner may take a certain percentage of a loser's asset inventory. The game asset exchange module 530 may also invoke the game asset update module 565 to update the records to reflect the exchange.

The game asset transaction module 535 may communicate with parties who intend to conduct transactions involving certain game assets. Such parties may be a game player, an investor, a game developer, a game operator, or the manager 105 itself for the purpose of controlling the market. The game asset transaction module 535 may participate in different stages of a transaction such as setting up a virtual space where an interested party can make an offer to sell, an offer to buy, etc. It may also facilitate matching sellers with buyers according to various criteria such as the types of goods for which interests are expressed, price offered and willing to accept, or type of underlying parties. The game asset transaction module may also provide means to help participants to conclude the deals by, e.g., confirming with the clearing house 555 for payment, conducting the transaction in compliance with the rules by interacting with the rule enforcement module 550, transferring funds for payment, and updating the records by invoking the user account management module 560, and updating the asset records associated with the transacting parties by invoking the game asset update module 565.

Another aspect of the present teaching is that the trade manager 120 can manage a virtual real-time auction in a manner which may be analogous to a stock exchange or a commodity market. Game assets can be bought and sold within this auction market and values of such game assets change dynamically with the development of the market. Such an auction market may be operated by the game asset auction module 540. The operation of an auction market may be managed in a substantially similar manner as that of the game asset transaction module as to carrying out the necessary operations to conclude a trade. However, there may be differences, e.g., the auction market may be managed based on different governing rules, which may vary from locale to locale.

The game asset rental module 545 manages aspects relating to renting game assets. While some aspects of a rental market may be similarly managed as in a normal transactional world, the rental market may have its own governing rules and enforcement scheme. For example, the rental market may require continuous enforcement according to the agreed terms, e.g., stipulated rental payment amount and payment schedule, and compliance with other rental terms during the lease term. The game asset rental module 545 may interact with outside advertising agencies to help its user to place ads, to monitor responses, to prepare a lease agreement, and to enforce the lease terms during the entire rental period.

As discussed above, besides managing the game assets and trades thereof, the manager 105 further includes the game asset market control manager 130, which may monitor and control the market driven by game assets. For example, in accordance with economic principles, the frequency or supply of a commodity within a market may have an impact on its economic value. To avoid overflow or underflow of a game asset in the marketplace (which may affect the value of the asset), the market control manager 130 may monitor and/or optimize the frequency with which a particular piece of game asset occurs in the marketplace. Using the sports card example, the market control manager 130 may determine how often a particular player's card should appear in a deck of cards so as to preserve its economic worth. Using the car racing game as another example, the market control manager 130 may employ specific methods to control the occurrence of a particular part in the market (e.g., the gaming world or general marketplace) and thus its supply in the game asset driven economy.

Consumers can purchase pre-packaged collections of assets. This serves as an effective method of controlling the supply of individual assets in the overall economy. In the football video game example, a consumer can purchase a package (similar to a pack of playing cards) of players. In a car game, players may purchase a “junk heap” that has a pre-determined number of parts of differing types and values. The manner by which these packages are constituted can be controlled by the market control manager 130. Though the specific manner differs between games, assets may be sold as a bundle—with a fixed number of assets in each bundle—at a set price. The effect is very similar to sports cards in that a consumer, having made a financial investment, can expect a differing economic worth for each collection of assets. Some collections may contain valuable game pieces and may be instantly profitable and effective in game play. Because of the differing value of each package, purchasing such packages may be a useful way to build a strategically more valuable inventory of game pieces without having to purchase each asset at the current market price.

The contents in a game asset package can be so determined to ensure that the introduction of individual assets in the package likely will correctly reflects the desirable percentage so that each asset should exist to preserve their relative economic worth. If the supply of an asset becomes too high within the game asset driven economy, the frequency at which this asset is incorporated in a package or introduced as a new asset to the market will decrease.

Since the most common assets are created first, a full series of assets occurs when the most rare asset is created. For example, if the most valuable (and therefore most rare) asset occurs one out of every two million assets created, then a full series is two million assets. The overall optimal frequency of each asset is determined by its worth in relation to other assets as determined, e.g., by dynamically changing real-world fluctuation of each asset in relation to one another. The market control manager 130 may assign a rank with respect to each asset as it scales in value. Each rank may be associated with a set number of optimal occurrences in a series, which may be first determined by game designers.

Based on the ranking, the manager 105 may control the relative frequency of the different assets in different ways to adjust the relative frequencies based on, e.g., some strategic considerations or policies. For example, when asset packages are created for sale, they may be created so as to adjust the relative frequencies of assets towards some desired frequencies balance with respect to one another. As another example, the market control manager 130 can purchase assets existing in the market place and place them into asset packages. Such purchases may be made in, e.g., real-time auctions at some discount rate. In this manner, when an asset is short of supply in the market place, the market control manager 105 may operate to purchase such assets from, e.g., auctions at a discounted rate, and to re-introduce them back into the market place, rather than issuing new assets. This ensures a healthy volume of trading, which bolsters the overall value of all assets in the economy.

As the real-world value of each asset changes, the market control manager 130 may control to introduce a corresponding relative shift in the market price for that asset. The market control manager 130 may also control to introduce a corresponding change in, e.g., the rate at which that asset is introduced to the market.

The manager 105 is also capable of buying back assets that have been put up for sale by the respective owners from within the game asset driven economy. As described herein, this may be activated if it is determined that the asset is needed for placement elsewhere within the economy, such as in new sets of cards. The market control manager 130 may also control to destroy or remove assets from the market as necessary from time to time to maintain a proper balance in the marketplace. Each game may have limits as to how many and what types of assets can be maintained and how many assets a single player may own in his inventory. Rules may also be put in place to require a player to place the surplus assets for sale on the auction if the limits on the inventory are exceeded.

There may also be limits on how long an asset may stay at an auction before it is removed or how often an asset can be placed up for auction. Given such constraints, a consumer may need to make decisions about which assets to keep and which to sell. Such decisions may be made so that the inventory remains at a highest benefit for the player. These economic mechanisms may be designed to increase the volume of overall trading and to provide a mechanism for balancing the economy, providing for an efficient market, and possibly to ensure that the company employs the market control manager 130 can maintain a predictable profit margin on the virtual assets it trades.

The market control manager 130 may also provide the ability to match players for races based on their individual ability in the game, e.g., car racing, in order to, e.g. consolidate game assets. Such match may be determined based on statistical analysis based on the inventories of the players, their individual winning records in the past, etc. The matching is determined when a statistically likely outcome will fulfill the goal of consolidate the game assets. In some instances, the outcome may not be what the market control manager 130 estimated because although the statistical chance that a player with a more valuable car will win is greater, crashes, weather, tire blowouts and other random occurrence may lead to an inferior car winning a race. Thus, a player with an exceptional car who wishes to race less valuable cars in hopes of acquiring parts has much more to lose.

Due to that there may be a limit to how many parts a player can hold in inventory, perhaps related to the amount of storage space the player owns, when a player exceeds this limit, he or she may have to sell the surplus parts, either individually or at auction. If the parts are not sold in a reasonable time, the player may choose to discard some parts in order to keep the more valuable parts in the available space. Typically, the player may desire to discard less valuable or less useful parts. The market control manager 130 may also facilitate players in making such decisions. In some embodiments, such control may be exercised at a consulting basis when a player requests the service. In some embodiments, such control can be exerted automatically on players' inventories with, e.g., confirmations from the players.

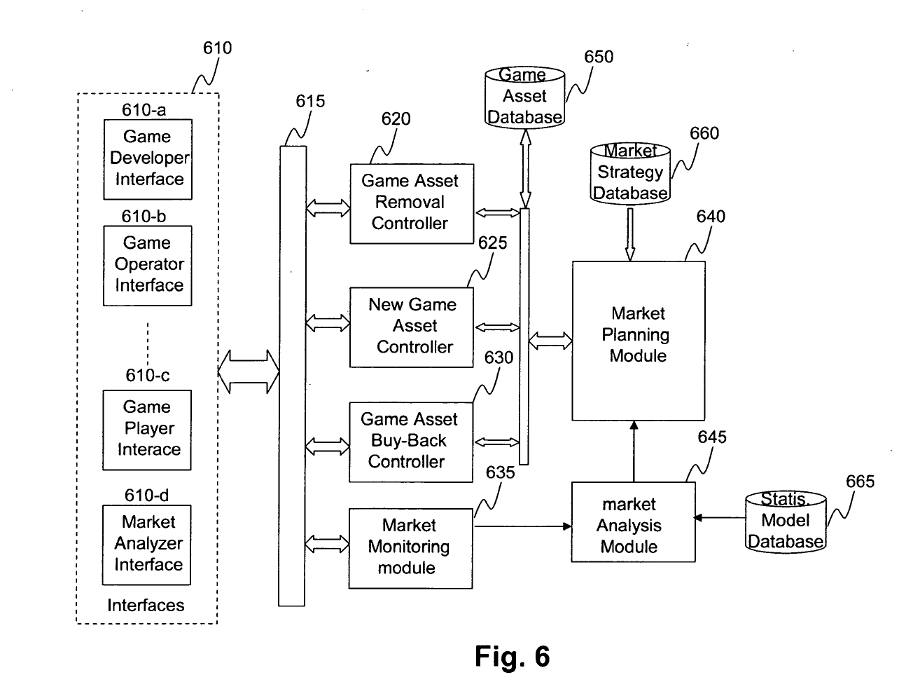

FIG. 6 is an exemplary block diagram for the market control manager 130, according to an embodiment of the present teaching. The exemplary block diagram comprises a plurality of interfaces 610, a communication platform 615, a game asset removal controller 620, a new game asset controller 625, a game asset buy-back controller 630, a market monitoring module 635, a market analysis module 645, a market planning module 640, and a plurality of databases (650, 660, and 665) storing information that facilitates the market management.

Interfaces 610-a, 610-b, 610-c, . . . , 610-d are provided to facilitate interactions between the market control manager 130 and other parties involved in making the market control decisions. The communication platform 615 is provided to facilitate the internal interactions between the interfaces 610 and various internal modules. The game asset removal controller 620 is responsible for controlling when a game asset is removed from either a player's inventory or from the market. The new game asset controller 625 is designed to be responsible for controlling introduction of new game asset either to the market or to the players' inventories. The game asset buyback controller 630 is provided for controlling the aspects of when and how game assets are to be bought back from either an auction or a sale in order to balance or optimize the value of the game assets.

The market monitoring module 635 is provided for performing various tasks related to market monitoring such as determining strategically the aspects of the market to be monitored, gathering market information from different sources, and performing certain processing of gathered information to produce results needed by the market analysis module 645. Once the market information is sent from the market monitoring module 635, the market planning module 640 performs market analysis to produce result that is useful for making decisions related to market control.

The plurality of databases include a game asset database 650, a market strategy database 660, and a statistical model database 665. The game asset database 650 may record all assets including ones that are currently available on the market, ones that are currently not available on the market but may be made available later in time, and ones that have been removed from the market in a specified past period of time. The recorded assets may be indexed via various useful indices such as index based on inventories of players, index based types, index based on status, or index based on frequency, or indices based on different combinations of indices.

The statistical model database 665 may be provided to store information relating to statistical models that can be applied in performing market analysis. With this database, the market analysis module 645 may perform alternative analysis of the market information and provide alternative market analysis results to the market planning module 640. The market strategy database 660 is provided to store information relating to different market planning strategies to facilitate the market planning module 640 to devise alternative plans as to market planning and to optimize the strategy when more than one alternatives exist.

There are various other management aspects associated with managing the economy driven by game assets, including both the game world economy 140 and the game asset driven economy 145 (FIG. 1 and FIG. 2). As discussed above, the general manager 125 in FIG. 1 and FIG. 2 is provided to serve as a catch-all manager for other various aspects of managing the economy. Such aspects may include game-specific and non game specific issues. For example, in a game world, certain games may allow team ownership. A knowledgeable player may opt to custom design and manage several premium cars that are raced in a large NASCAR-style race that may take hours to complete. Because a team owner may not be able to race all of his cars himself, he may choose to “hire” drivers and a pit crew to race his cars and to increase his chances of winning a race. These services may be purchased from other owners or players. The general manager 125 may be invoked to provide assistance to the team owner to determine who the best drivers in the overall game world are and to assist to connect the team owner with the drivers he identified. The team owner may rely on the general manager 125 to make an offer to those drivers to race his cars. The team owner may also rely on the general manager 125 to hire a pit crew to change tires and gasoline. The general manager 125 may also assist the team owner to buy items from a player who owns and runs, e.g., a virtual gas station or tire shop, instead of spending the time manufacturing those parts for maximizing the profit margin of the team owner.

While the inventions have been described with reference to the certain illustrated embodiments, the words that have been used herein are words of description, rather than words of limitation. Changes may be made, within the purview of the appended claims, without departing from the scope and spirit of the invention in its aspects. Although the inventions have been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

1. A method in a game asset driven economy, comprising:
estimating the economic value of a game asset that has a utility in a game; and
managing a market in which the game asset can be transacted at a price determined based on the economic value of the game asset.

2. The method of claim 1, wherein the game asset has one or more attributes.

3. The method of claim 2, wherein the one or more attributes are correlated with the utility of the game asset in the game.

4. The method of claim 3, wherein each of the one or more attributes has a value.

5. The method of claim 4, wherein the initial value of an attribute is assigned by one of a game developer and a game operator based on a desired level of utility.

6. The method of claim 5, wherein the value of the attribute is updated by at least one of a game developer, a game operator, and a third party.

7. The method of claim 1, wherein the game asset includes at least one of a virtual object, a virtual character, and a feature associated with a virtual object or a virtual character.

8. The method of claim 7, wherein the virtual object includes a virtual weapon, a virtual vehicle, and a virtual tool.

9. The method of claim 7, wherein the feature includes a property, a skill, an ability, a concept, a condition, a privilege, and a quality.

10. The method of claim 7, wherein the game asset further comprises an idea.

11. The method of claim 1, wherein the game asset has a owner who is capable of exercising a plurality of property rights associated with the game asset.

12. The method of claim 1, further comprising managing the game asset.

13. The method of claim 12, wherein the managing the game asset comprises:
recording information associated with the game asset;
activating the step of the evaluating the game asset at an appropriate time; and
updating the recorded information associated with the game asset when there is a change in the information.

14. The method of claim 13, wherein the information includes at least one of:
one or more attributes associated with the game asset and values thereof;
a specification of the utility of the game asset with respect to a game;
a specification of a relationship between the market price of the game asset and a level of utility of the game asset;
a definition of a correlation between the utility of the game asset and one or more real world events that affect the utility of the game asset;
an ownership associated with the game asset;
a market price of the game asset;
a definition of a correlation between the utility of the game asset and the market price of the game asset;
a gaming history of the game asset; and
a transaction history of the game asset.

15. The method of claim 13, wherein the appropriate time is when an occurrence of a real-world event defined in the information associated with the game asset is detected.

16. The method of claim 13, wherein the managing the game asset further comprises changing the ownership of the game asset.

17. The method of claim 13, further comprising managing an account of a gamer including an inventory of the game assets that the gamer owns.

18. The method of claim 13, wherein the managing the game asset further comprises removing the game asset from an inventory associated with a gamer.

19. The method of claim 13, wherein the managing the game asset further comprising adding the game asset to an inventory associated with a gamer.

20. The method of claim 13, further comprising;
providing means for creating a game asset and specifying one or more attributes associated with the created game asset;
providing means for assigning values to the one or more attributes.

21. The method of claim 13, further comprising:
providing means for specifying a relationship between the market price of a game asset and values of attributes of the game asset; and
updating the market price according to the values of attributes of the game asset based on the relationship specified.

22. The method of claim 21, further comprising:
providing means for specifying a relationship between the utility of a game asset and the market price of the game asset; and
updating the utility of the game asset according to the market price of the game asset based on the relationship specified.

23. The method of claim 13, further comprising placing the game asset for sale based on a market price of the game asset.

24. The method of claim 1, wherein the managing the market comprises enabling the market by facilitating an economic activity conducted with respect to a game asset.

25. The method of claim 24, wherein the economic activity includes performing a transaction associated with a game asset.

26. The method of claim 25, wherein the transaction is performed in real-time using at least one of a device, a telephone, a mobile phone, a Personal Data Assistant, and a wireless device.

27. The method of claim 24, wherein the economic activity includes at least one of buying, selling, and renting a game asset based on the market price of the game asset.

28. The method of claim 27, wherein the economic activity involves a discounted price offered in exchange of an act.

29. The method of claim 28, wherein the act includes watching an advertisement.

30. The method of claim 28, wherein the act includes branding a game asset with a logo.

31. The method of claim 24, wherein the economic activity includes an auction in which a game asset is transacted.

32. The method of claim 24, wherein the economic activity is conducted by establishing a contractual relationship among a plurality of parties with one or more contractual terms.

33. The method of claim 24, wherein the enabling the market further comprises facilitating monetary exchanges between parties involved in an economic activity.

34. The method of claim 33, wherein currency involved in the monetary exchange is virtual.

35. The method of claim 24, wherein the enabling the market further comprises:
specifying a commission rule associated with an economic activity;
paying a commission based on the commission rule.

36. The method of claim 24, wherein the enabling the market further comprises:
specifying a discount rule governing a discount sale of a game asset;
carrying out a discount sale of the game asset based on the discount rule.

37. The method of claim 1, wherein the managing the market comprises controlling the market.

38. The method of claim 37, wherein the controlling the market comprises:
creating rules by which a game asset is introduced to and/or removed from the market;
introducing a game asset to the market based on the rules; and
removing a game asset from the market based on the rules.

39. The method of claim 37, wherein the controlling the market further comprises:
creating rules associated with an game asset inventory; and
auctioning a game asset in the game asset inventory based on the rules.

40. The method of claim 39, further comprising removing the game asset from the auction based on the rules.

41. The method of claim 37, wherein the controlling the market further comprises:
monitoring a market in which a game asset is valued and can be transacted;
analyzing the market based on observations made in the monitoring;
devising a market strategy relating to the market based on the result from the analyzing; and
conducting an economic activity in the market in accordance with the strategy.

42.-69. (canceled)
